(19) United States
(12) Patent Application Publication
(10) Pub. No.: US 2007/0219646 A1
(43) Pub. Date: Sep. 20, 2007

(54) DEVICE PERFORMANCE APPROXIMATION

(75) Inventors: John M. Oslake, Seattle, WA (US); Glenn Peterson, Kenmore, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/276,949

(22) Filed: Mar. 17, 2006

(51) Int. Cl. G05B 13/02

(52) U.S. Cl. 700/32

(57) ABSTRACT

Embodiments relate to determining a value of a type of performance parameter of a target device configuration that has known values of various types of configuration attributes. Reference device configurations can be obtained that respectively having known values for types of configuration attributes corresponding to the types of configuration attributes of the target device and respectively having known values of the type of performance parameter whose value is to be determined for the target device. The performance parameter values of the reference device configurations can be weighted based on the reference device configurations' respective distances from the target device configuration in a space defined by the types of configuration attributes, where the types of configuration attributes correspond to respective dimensions of the space. The weighted performance parameter values of the reference device configurations can be used to determine the performance parameter value of the target device.

### BACKGROUND

It is sometimes desirable to be able to approximate a performance characteristic of a device when only limited information about the device is known. This kind of approximation may be desirable, for example, when planning to maintain or upgrade an Information Technology (IT) infrastructure. When planning IT infrastructure it may be helpful to know performance characteristics of devices that might be added to the IT infrastructure, devices such as soon-to-be-available disk drives and CPUs for which performance statistics, perhaps measured, are not yet available. Performance statistics are often not available when a producer of a device has announced a new device but has not yet made the device available for testing or benchmarking. Sometimes, devices that have been available for testing and benchmarking may not have been tested or benchmarked due to the very large number of devices and the effort needed to perform the testing or benchmarking. Of course, performance statistics are also not available for projected or hypothetical future devices. While a hypothetical future device may be assumed to have some basic characteristics or parameters (e.g. disk RPMs, processor clock speed, etc.), performance measures (e.g., a benchmark test data) for such a device will not exist, making it difficult to plan IT changes around such a device. In sum, there is a need to be able to approximate performance characteristics of devices (whether actual or hypothetical) when perhaps the device can't be physically tested or when information about the device is incomplete.

### SUMMARY

The following summary is included only to introduce some concepts discussed in the Detailed Description below. This summary is not comprehensive and is not intended to delineate the scope of the claimed subject matter, which is set forth by the claims presented at the end.

Embodiments relate to determining a value of a type of performance parameter of a target device configuration that has known values of various types of configuration attributes. Reference device configurations can be obtained that respectively having known values for types of configuration attributes corresponding to the types of configuration attributes of the target device and respectively having known values of the type of performance parameter whose value is to be determined for the target device. The performance parameter values of the reference device configurations can be weighted based on the reference device configurations' respective distances from the target device configuration in a space defined by the types of configuration attributes, where the types of configuration attributes correspond to respective dimensions of the space. The weighted performance parameter values of the reference device configurations can be used to determine the performance parameter value of the target device.

Many of the attendant features will be more readily appreciated by referring to the following detailed description considered in connection with the accompanying drawings.

### DESCRIPTION OF THE DRAWINGS

Like reference numerals are used to designate like parts in the accompanying Drawings.

FIG. 1 shows a set of device configurations.

FIG. 2 shows a process that can be used to approximate a performance characteristic of a new or target device, such as the new device configuration shown in FIG. 1.

FIG. 3 shows another process for approximating a device parameter.

FIG. 4 shows a set of disk configurations.

FIG. 5 shows a 3-dimensional configuration subspace.

FIG. 6 shows a 2-dimensional configuration subspace.

FIG. 7 shows a library of CPU configurations.

FIG. 8 shows a filtration precedence array.

FIG. 9 shows a filtering logic table.

FIG. 10 shows a logic table.

### DETAILED DESCRIPTION

The following description will discuss several embodiments for approximating performance parameters for any type of device. This will be followed by discussion of a specific embodiment directed to approximation of disk parameters and discussion of a specific embodiment for approximating CPU parameters.

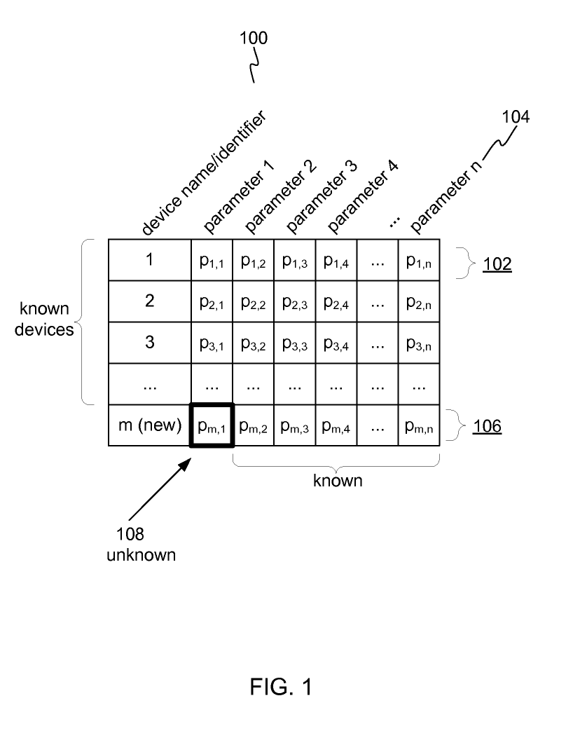

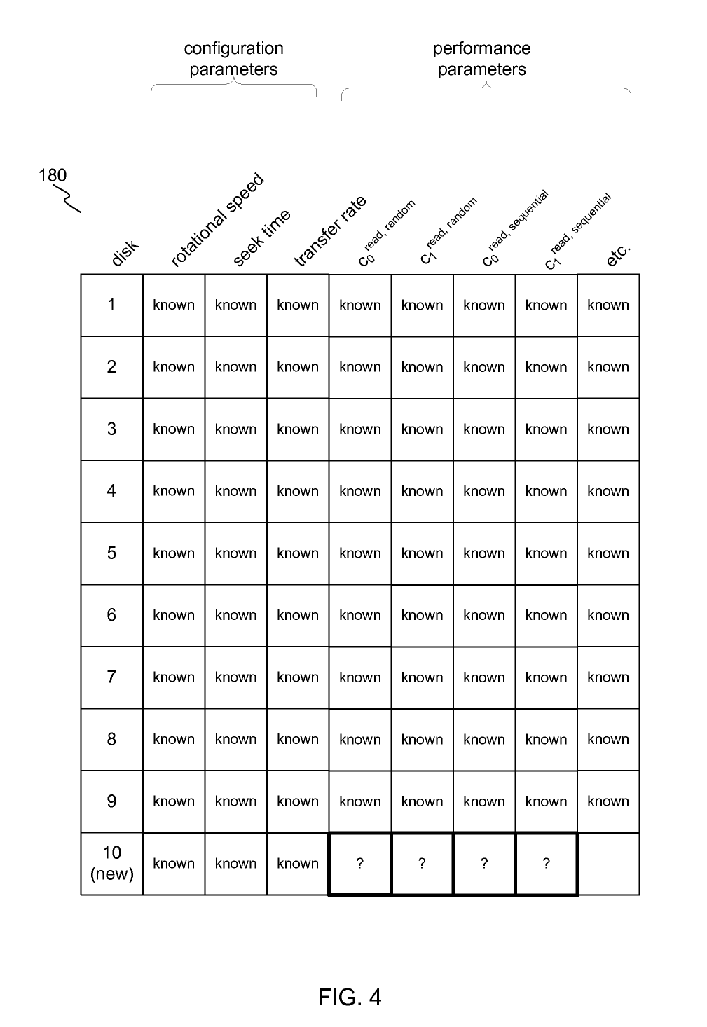

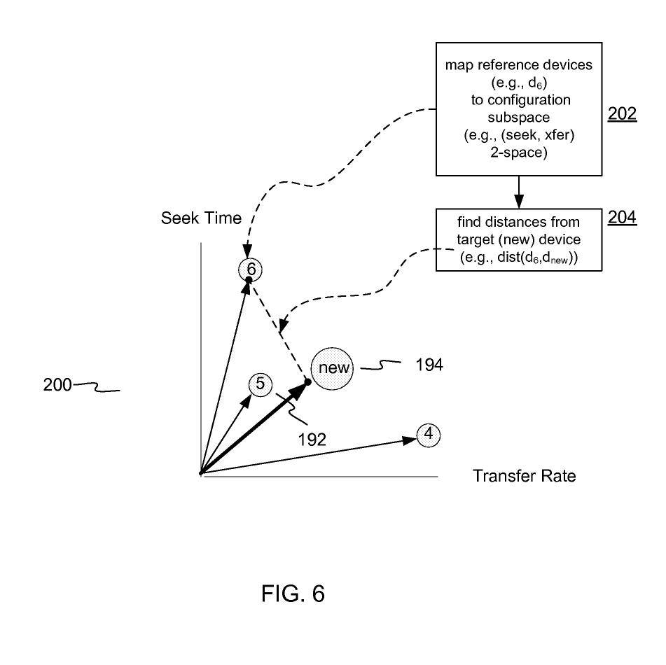

FIG. 1 shows a set of device configurations 100. The set may be stored in a database table, a spreadsheet, a data structure in a computer's memory, etc. The set of device configurations 100 are assumed, for the purpose of discussion, to be of a same device type (e.g., CPU, memory, disk drive, automobile engine, etc.). In other words, individual device configurations 102 (rows or members of the set 100) can have the same types of attributes or parameters 104. See FIGS. 4 and 6 for examples of particular types of devices; disks and CPUs, respectively. The set of device configurations 100 contains a number of device configurations 102 of assumed or existing (known) devices. A configuration 106 of a new device is also shown. The configuration 106 can have the same types of parameters 104 as the known configurations. One or more of the parameters of the new device configuration 106 may be unknown, for example, entry m's parameters could be an unknown performance attribute such as a benchmark metric.

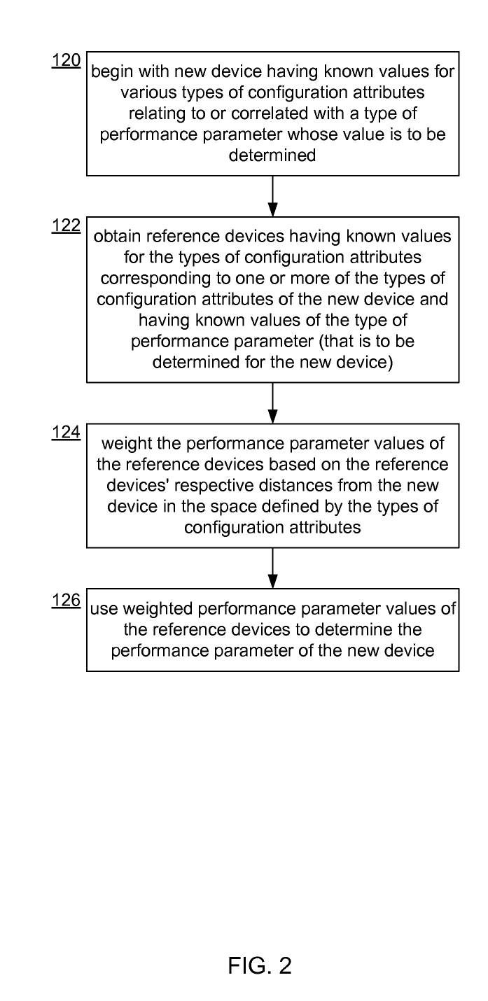

FIG. 2 shows a process that can be used to approximate a performance characteristic of a new or target device, such as the new device configuration 106 shown in FIG. 1. For discussion, the term “device” will be sometimes used to refer to the information corresponding to and representing a device, for example, a device configuration such as one of the device configurations shown in FIG. 1. The process in FIG. 2 begins 120 with a new device. The new device has known values for various types of configuration attributes (parameters) relating to or correlated with a type of performance parameter whose value is to be determined. For example, a CPU processor family and clock speed might be known. Then, the process involves accessing or obtaining 122 reference devices having known values for the types of configuration attributes corresponding to one or more of the types of configuration attributes of the new device. As will be seen later, the known configurations (those having the known values) will also have known values of the type of performance parameter that is to be determined for the new device. For example, the unknown device may have an unknown Standard Performance Evaluation Corporation (SPEC) benchmark value, and the obtained 122 configurations will have known SPEC values. Those known performance parameters of the reference devices are weighted 124 based on the reference devices' respective distances from the new device in the space defined by the types of configuration attributes. In other words, the “closeness” of the reference devices to the new device (in a known parameter space) is used to weight the reference performance attributes (e.g., SPEC values) that correspond to the desired (unknown) performance attribute of the new device. Finally, those weighted performance parameter values of the reference devices are used 126 to determine the performance parameter of the new device. For example, weighted known SPEC values would be used 126 to determine an approximate SPEC value for the new device. More detailed explanation of some of these steps will follow.

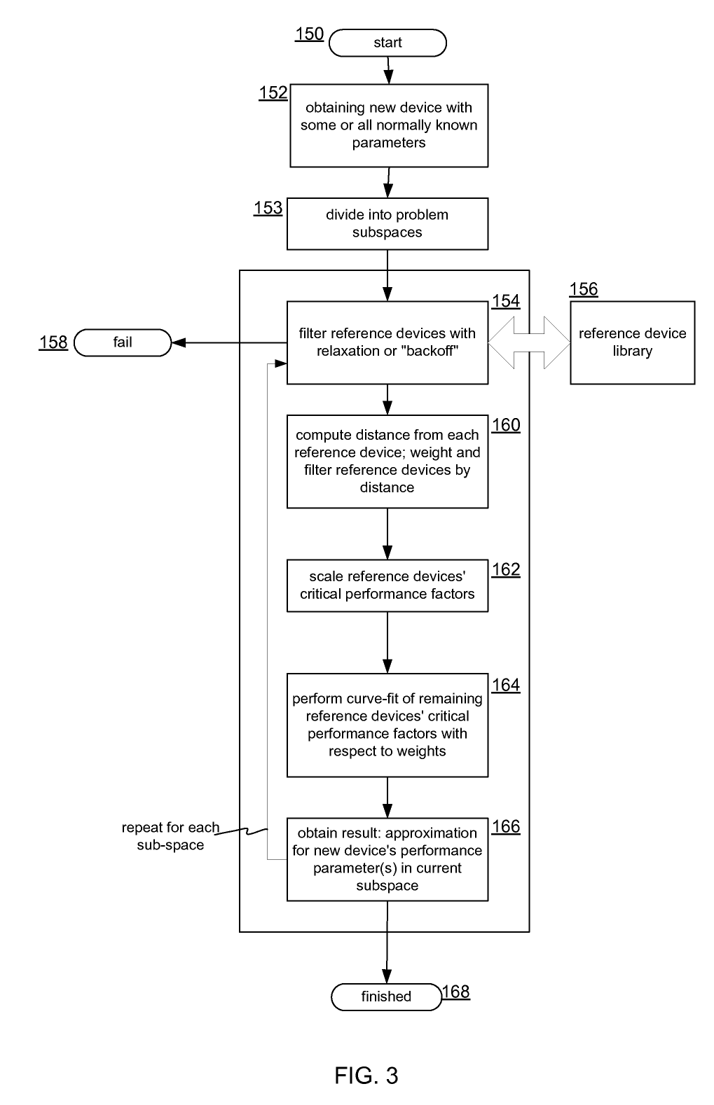

FIG. 3 shows another process for approximating a device parameter. The process shown in FIG. 3 starts 150 with obtaining 152 some new or target device with some or all normally known parameters. For example, if the obtained 152 device were an automobile engine, the obtained 152 device might have number of cylinders, engine displacement, maximum manifold pressure, compression ratio, fuel type, or some other parameters (but might lack performance parameters such as power and/or torque vs. RPM curves). In the case of a disk drive, the obtained 152 device might include known values for rotational speed, seek time, and transfer rate (see FIG. 4) but might lack values for random/sequential read/write performance parameters.

Because some types of devices have different critical parameters or performance parameters that depend on different combinations of types of configuration parameters, there may be a step of dividing 153 the configuration space into one or more subspaces. The dividing 153 results in a different approximation computation being performed for different target performance parameters, with approximation each being based on a different subset of configuration parameters of reference devices (even possibly different subsets of reference devices).

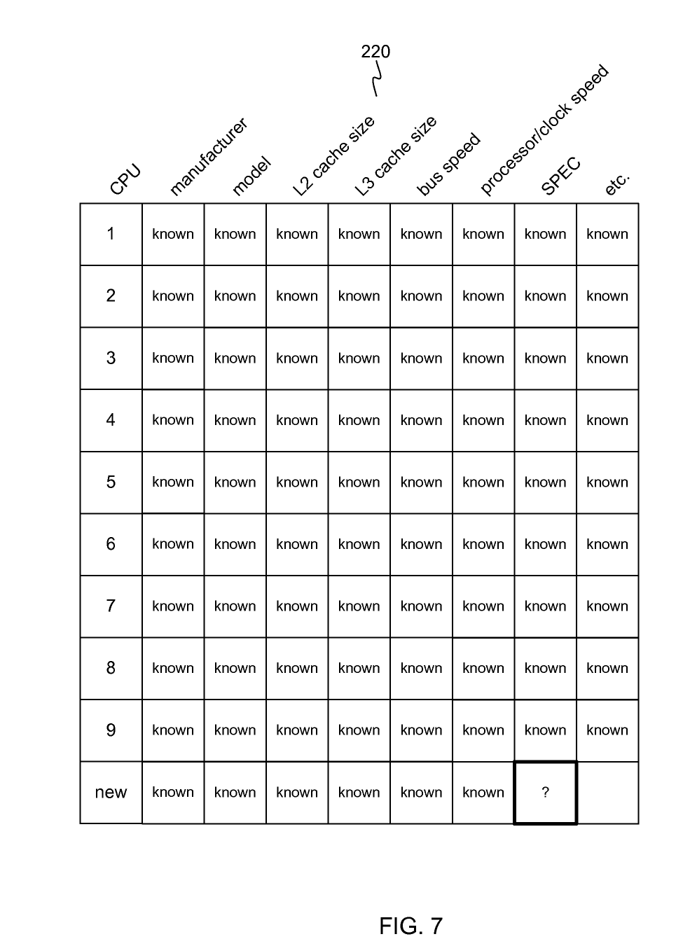

Whether the problem space is divided 153 or not, the process proceeds to filter 154 reference devices from a reference device library 156 to obtain a set of devices that will be the basis for obtaining an approximation. The reference device library 156 may store different types of device configurations (see FIG. 1). Filtering 154 involves searching a set of device configurations such as that shown in FIG. 1. The idea of filtering 154 is to find reference devices that have similarities (e.g., common configuration parameters with perhaps equal or “close” values) to the target device (obtained 152 device). The filtering 154 can also relax or “backoff”. That is, criteria for filtering 154 can be relaxed (or tightened) as needed to obtain a suitable pool of reference devices. For an example, see FIG. 7. In one embodiment, there may be ordered filter criteria, such that the library 156 is filtered for devices which match the new or target device, and if an insufficient number of library devices match the new device according to the filter criteria, then the filter criteria is relaxed and retried. If the filter criteria are fully relaxed and insufficient matches are found, then the approximation process fails 158. The relaxation sequence may be ordered according to the order of importance of configuration parameters in determining the accuracy of the approximation, where the importance is determined by the strength of the correlation between the configuration parameters and the performance parameters. That is, parameters which are less important can be relaxed before parameters which are more important. Other ordering bases may be used.

If the filtering 154 produce a sufficient base of reference devices, then the approximation process moves on to compute 1 60 the distance from each reference device (that passed through the filtering 154). As discussed previously, this can be performed by taking some measure (e.g., Euclidean, Manhattan, etc.) of the distances between the reference devices and the target device in the n-space defined by the n configuration parameters relevant to the current subspace being processed (i.e., configuration parameters for which the target device has known values). The reference devices can also be filtered based on their distance and the reference devices can be weighted according to their distance. In other words, a distance function can be used to both qualify and weigh reference devices in resultant approximations. As an example, distances can be used to compute normalized weights based on the inverse of the distances. If, for example, the distances from the target device to two reference devices were 3 and 4, the normalized weights would be ⅓/(⅓+¼)=0.57 and ¼/(⅓+¼)=0.43. Given weighted distances, the reference devices can be selected in any number of ways. The reference devices can be ordered by their weighted distances and a maximum of the first N devices can be selected. The first N devices with a weighted distance under a threshold can be selected. Or, the first N devices within a statistical range can be selected.

It may be desirable for some types of devices to scale 162 the performance parameters of the reference devices. This can allow greater emphasis to be given where needed. For example, if the target performance parameter type is a SPEC benchmark, it may be that CPU performance generally scales directly with a CPU's clock speed. In such a case, a post-filtering scale factor of (new device clock speed)/(reference device clock speed) would be applied to scale 162 a reference CPU's SPEC value.

After scaling 162, optional curve fitting 164 may be applied to the filtered reference devices' performance parameter values to obtain a function that is evaluated with the new device's various known configuration parameters (or at least those that are part of the current subspace if the problem has been subspace-divided).

Finally, the performance parameter values, as possibly altered in accordance with steps discussed above, are used to obtain 166 an approximation of the new device's performance parameter(s). For example, the approximation may be a weighted average of the performance parameter values of the reference devices. Other approaches will be discussed later with reference to CPU and disk examples. If there are multiple problem subspaces, then the approximation process may be repeated. Otherwise, the process is finished 168.

Following is a discussion of an embodiment for disk drives. FIG. 4 shows a set of disk configurations 180. In this library of devices, existing devices (disks 1 through 9) and new device (disk 10) are all assumed to have known values for certain types of configuration parameters such as rotational speed, seek time, and transfer rate. A disk configuration can be parameterized as: Time=c₀^{IoOperation,IoPattern}+c₁^{IoOperation,IoPattern}·IoSize (1), where where c₀^{IoOperation,IoPattern} and c₁^{IoOperation,IoPattern} are constants usually empirically derived through benchmarking. IoOperation is either “read” or “write”, and IoPattern is either “random” or “sequential”, so each configuration is represented by eight constants (only four are shown in FIG. 4). Benchmarks for the new disk configuration are determined by weighting benchmarks of existing configurations as a function of the distance between the new configuration and existing configurations.

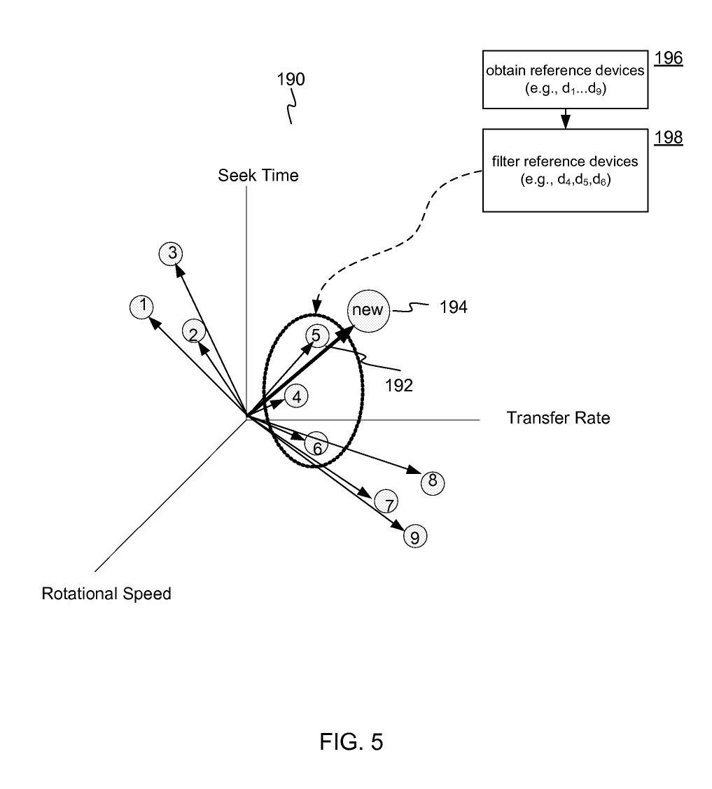

FIG. 5 shows a 3-dimensional disk configuration subspace 190. Consider RotationalSpeed, SeekTime, and TransferRate as a possible subset of disk configuration parameters that is expected to play a role in approximating the various performance parameters c0 and c1. These parameters define the example 3-dimensional subspace 190 of disk configurations 180 shown in FIG. 4. The disk configuration subspace 190 shows all 9 configurations in the existing library of configurations 180. Subspace 190 also shows new configuration 194 (disk 10) to be added to the library of disk configurations 180. Note that configuration 5 192 (disk 5) is the nearest neighbor of the new configuration 194. Furthermore, configurations are expected to be clustered since rotational speeds and seek times tend to be correlated. However, the approximation technique does not depend on the validity of this observation.

If the rotational speed is considered to be a particularly crucial performance parameter, then the reference configurations used in the approximation should be filtered by this parameter. Filtering can be accomplished by selecting disk configurations which are not approximated (i.e., those which have measured values for performance parameters c0 and c1) and which satisfy RotationalSpeed_{new}=RotationSpeed_{existing}. In other words, from among disks 1 through 9, configurations are selected for which the rotational speed value matches (or perhaps is within some range of) the rotational speed value of new disk 10. This filtering reduces the dimensionality for the configuration subspace from three dimensions to two dimensions. This 2-dimensional subspace 200 is shown in FIG. 6. Note that in general the approximation method is structured to be independent of the subspace dimensionality.

To help relate the subspace 190 to filtering steps, FIG. 5 also shows steps 196 and 198. Preferably all reference devices are obtained 196 from the configuration library, and then filtered 198 to obtain the final set of reference devices used in the approximation.

In general, suppose the set of filtered disk configurations contains n such configurations where c_{0,1} . . . c_{0,n} and c_{1,1} . . . c_{1,n} represent the benchmark constants c0 and c1, respectively, for configurations 1 . . . n. Further suppose, a new disk configuration is to be added to the library, but that its benchmarks c_{0,new} and c_{1,new} are unknown.

For each filtered configuration i, denote its seek time and transfer rate by seekᵢ and transᵢ, respectively. Then, given the selected disk configurations, the configuration points (vectors) in the subspace may be scaled according to:

$$( seek , trans ) ↦ ( \frac{a \cdot seek}{{max}_{i} {seek}_{i}} , \frac{β \cdot 1 / trans}{{max}_{i} 1 / {trans}_{i}} )$$

where α and β are configuration parameter biases and maximum values are computed over all filtered configurations. This rescales parameter values to unitless quantities and enables subsequent control of parameter value biasing in the subspace approximation.

It can be shown that the mapping of trans into its inverse leads to a more accurate approximation. Also, this inversion more consistently orders points in the subspace so that the configuration distance from the origin (norm) is (inversely) related to the configuration performance. More specifically, each coordinate becomes a measure of latency.

Configuration distances to the new disk may then be calculated. For each filtered configuration xᵢ in the mapped configuration subspace, the distance dᵢ to the new configuration x_{new} is calculated. For example, d may be computed using the 2-norm ∥·∥₂. That is,

$${d}_{i} ( {x}_{i} , {x}_{new} ) = \sqrt{{( se \tilde{e} {k}_{new} - se \tilde{e} {k}_{i} )}^{2} + {( {\tilde{trans}}_{new} - {\tilde{trans}}_{i} )}^{2}}$$

where x=(se\tilde{e}k,trãns) is a point (vector) in the mapped configuration subspace.

To help relate the subspace 200 to approximation steps, FIG. 7 also shows steps 202 and 204. The filtered reference devices are mapped 202 to the two-dimensional configuration subspace 200, and distances are found 204 between the reference configurations and the new configuration.

Performance parameter values may then be weighted. For each filtered configuration xᵢ in the mapped configuration subspace, performance weights are defined as

$${w}_{0 , i} = \frac{1}{{d}_{i} ( {x}_{i} , {x}_{new} ; α = {α}_{0} , β = {β}_{0} )} and$$

$${w}_{1 , i} = \frac{1}{{d}_{i} ( {x}_{i} , {x}_{new} ; α = {α}_{1} , β = {β}_{1} )} ,$$

where w_{0,i} are the weights used in the approximation for c_{0,new}, and w_{1,i} are the weights used in the approximation for c_{1,new}. These weights amplify performance contributions of nearby neighbor configurations. Although it may be assumed that d=∥xᵢ−x_{new}∥₂, other distance metrics may be used. Furthermore, although it may be assumed that α₀=62 ₀=1.0 and α₁=β₁=1.0, other approaches may be used if the correlations between c_{0,new} and c_{1,new} and SeekTime and TransferRate are known. For example, α₀=1.0, β₀=0.1 would favor SeekTime in the approximation for c_{0,new}. And, α₁=0.1, β₁=1.0 would favor TransferRate in the approximation of c_{1,new}. Note that this biasing creates two 2-dimensional configuration subspaces. Note also that if a filtered configuration exists which is identical to the new configuration in the critical subspace, then the amplification is infinite. In this case, performance values are also taken to be identical and the approximation process can terminate.

Finally, performance parameters (in this case, benchmarks) for the target device can be approximated. Each benchmark of the new configuration is calculated as a weighted average: c_{0,new}=1/w₀·Σᵢ₌₁ⁿc_{0,i}·w_{0,i} and c_{1,new}=1·Σᵢ₌₁ⁿc_{1,i}·w_{1,i}, where w₀=Σᵢ₌₁ⁿ w_{0,i} and w₁=Σᵢ₌₁ⁿ w_{1,i}. These calculations are performed for each combination of IoOperation and IoPattern.

Following is a discussion of an embodiment for CPUs. FIG. 7 shows a library of CPU configurations 220. The configuration parameters are defined by the Manufacturer, Model, ProcessorCount, CoresPerProcessorCount, HyperthreadsPerCoreCount, ProcessorSpeed, L2CacheSize, L3CacheSize, and BusSpeed. The performance parameter is given by the SPEC benchmark. It is desirable for a CPU's configuration to include its SPEC benchmark, for example, to enable resealing of workload between different configurations. In this example, the SPEC benchmark is a single constant. The SPEC benchmark for a new configuration can be approximated as follows.

Existing CPU configurations are filtered. Filtering is done by selecting from the library of CPU configurations 220 those CPU configurations which are not approximated and which satisfy Manufacture_{new}=Manufacturer_{existing} and Model_{new}=Model_{existing}. These parameters are preferably identical for existing configurations to be considered as candidates in the approximation. If no existing configurations satisfy this filter, then the approximation attempt is aborted. If additional parameters are also identical, then the approximation can be improved. In the limiting case that all parameters are identical, the configurations are considered identical including their benchmarks. A filter relaxation scheme, discussed below, can be used to attempt to further restrict existing configurations considered in the approximation.

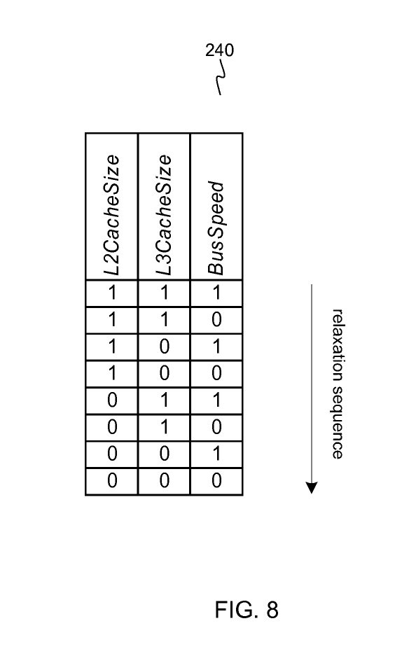

FIG. 8 shows a filtration precedence array 240. The filtration precedence array 240 is an array of bit-masks for configuration parameters which are candidates for filter relaxation. Each bit in the mask (row) indicates the truth value of parameter equality between the new (target) configuration and existing configurations in the CPU configuration library 220. For example, the bit-mask (1, 1, 0) corresponds to the case where new and existing configurations have identical L2CacheSize and L3CacheSize, but their BusSpeed differs. Each bit-mask represents a filter choice. Although the sequence of bit-masks happens to be binary (where 7,6,5,4,3,2,1,0 are the values of the bit-mask), this is not a requirement. The use of bit-masks is merely an implementation convenience.

The ordering of bit-masks in the filtration precedence array 240 specifies the filter relaxation (back-off) sequence, or precedence. For example, (1, 1, 1) is a preferred filter compared to (1, 1, 0), and so on. Preferably, the relaxation sequence terminates the first time at least one matching configuration is found. All configurations corresponding to the first nonempty bit-mask are the configurations used in the approximation.

To illustrate the filter relaxation scheme, suppose there are no existing configurations which satisfy bit-masks (1, 1, 1) and (1, 1, 0), but there are three existing configurations that satisfy bit-mask (1, 0, 0). Then only these three existing configurations pass the filtration and are considered in the approximation. It should be noted that in one embodiment, the relaxation scheme determines weights of the various distances, which are discussed below.

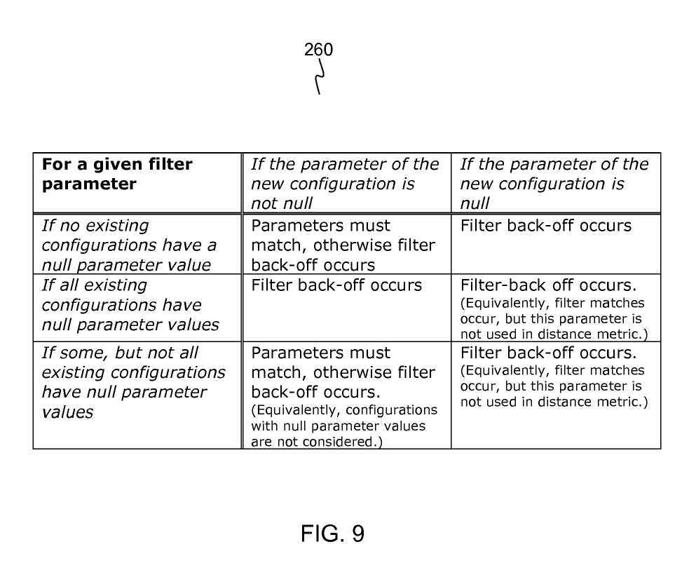

FIG. 9 shows a filtering logic table 260. Note that BusSpeed, L3CacheSize, and L2CacheSize may have null values (in both FIGS. 4 and 7, some of the “known” field values might in practice be “null”). To handle such cases, the filtering logic of table 260 may be used. The filtering logic table 260 specifies, according to various combinations of null values, whether back-off should occur.

The next stage in the SPEC approximation process is to define the configuration subspace. The de facto configuration subspace corresponding to the filtering above is defined by ProcessorCount, CoresPer ProcessorCount, HyperthreadsPerCoreCount, and ProcessorSpeed. Note that if multi-core scalability is assumed to be sufficiently close to multi-processor scalability, then the configuration subspace can be reduced further to ProcessorSpeed, CoreCount, and HyperthreadsPerCoreCount, where CoreCount=ProcessorCount·CoresPer ProcessorCount.

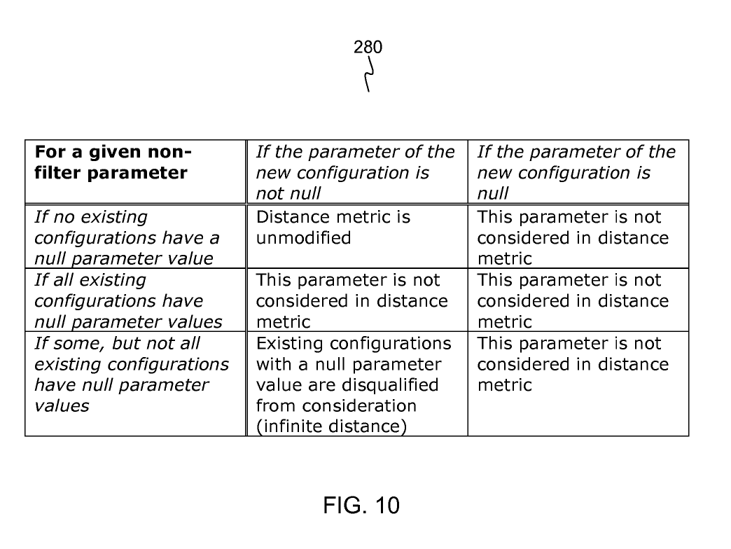

Configuration subspace resealing and configuration distance calculation can be performed as with the disk configuration resealing and distancing discussed in the example above. Note that BusSpeed, L3CacheSize, and L2CacheSize may have null values. In such cases, the distance metric is affected as shown in FIG. 10. FIG. 10 shows a logic table 280. Logic table 280 specifies how to compute distance for various null conditions in the new and existing configurations

The next step of SPEC approximation is to select the closest configuration. That is, the process finds the filtered configuration in the computed subspace with the minimum distance to the new configuration. This selected configuration is then used as the reference configuration in the resealing of the SPEC benchmark for the new configuration.

The SPEC benchmarks (performance parameter values) of the reference configurations are then rescaled. To this end, the SPEC benchmark for the new configuration, spec_{new}, is related to the SPEC benchmark for the reference configuration, spec_{ref}, as follows: spec_{new}=spec_{ref}·scale_{speed}·scale_{processor}·scale_{core}·scale_{thread}, where scale_{speed} is a function parameterizing speed resealing, scale_{processor} is a function parameterizing processor scalability, scale_{core} is a function parameterizing multi-core scalability, and scale_{thread} is a function parameterizing hyper-threading (tm) scalability. For purposes of this example, it may be assumed that scale

$${scale}_{speed} = \frac{{processorSpeed}_{new}}{{processorSpeed}_{ref}} , \\ {scale}_{processor} = {( {factor}_{processor} )}^{{log}_{\cdot 2} ( \frac{{procCount}_{new}}{{procCount}_{ref}} )} , \\ {scale}_{core} = {( {factor}_{processor} )}^{{log}_{\cdot 2} ( \frac{{coresPerProcCount}_{new}}{{coresPerProcCount}_{ref}} )} , \\ {scale}_{thread} = {( {factor}_{thread} )}^{{log}_{\cdot 2} ( \frac{{threadsPerCoreCount}_{new}}{{}_{{threadsPerCoreCount}_{ref}}} )} , where$$

$${factor}_{processor} = \frac{\sqrt{{n}_{1 \to 2}} {avg}_{system \cdot config} ( \frac{{spec}_{2 - proc}}{{spec}_{1 - proc}} ) + \sqrt{{n}_{2 \to 4}} {avg}_{system \cdot config} ( \frac{{spec}_{4 - proc}}{{spec}_{2 - proc}} )}{\sqrt{{n}_{1 \to 2}} + \sqrt{{n}_{2 \to 4}}} , \\ {factor}_{core} = {factor}_{processor} , and {factor}_{thread} = 1.22 .$$

The processor scaling factor factor_{processor} is computed by considering configurations which are identical with respect to all parameter values except ProcessorCount. Technically, this filter could be relaxed to admit system configurations which also differ in ProcessorSpeed, but this would introduce an additional resealing step. Note, n_{1→2} is the number of samples used to compute the average ratio between 2-processor and 1-processor SPEC benchmarks, and n_{2→4} is the number of samples used to compute the average ratio between 4-processor and 2-processor SPEC benchmarks.

The processor core scaling factor factor_{core} can be taken to be the same as factor_{processor} if there is sparse availability of benchmark data and/or good scalability is observed for multi-core configurations.

The constant 1.22 is from the WebBench benchmark. Currently, factor_{thread} reduces to 1.22 since hyper-threading (tm) technology only supports two threads per physical processor. In the future, if hyper-threading (tm) supports more threads, then ideally this benchmark should be updated and one or more new constants introduced, but is not strictly required.

The WebBench benchmark is used since the inventory of SPEC benchmarks for hyper-threaded configurations is very limited. As more SPEC benchmarks for hyper-threaded configurations become available, reliance on WebBench will become unnecessary.

In the future, to improve scaling accuracy it would be worthwhile to consider introducing scaling factors which are a function of the scaling regime, e.g., factor_{processor} is calculated for scaling from 1 to 2 processors only, is separately calculated for scaling from 2 to 4 processors only, and so on.

As discussed above, processes for approximating device parameters can be embodied in any variety of computation systems or media for enabling computation systems to perform such processes. Furthermore, some portions of such processes may actually be performed manually or via operator input to a computation system. For example, for an approximation, an operator might determine whether filtration should occur or what filtration criteria should be used. An operator might also select which types of parameters should be used for the subspace(s) of the selected or filtered pool of reference device configurations.

In conclusion, those skilled in the art will realize that storage devices used to store program instructions for implementing embodiments described above can be distributed across a network. For example a remote computer may store an example of a process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art, all or a portion of the software instructions may be carried out by a dedicated circuit, such as a DSP, programmable logic array, or the like.

All of the embodiments and features discussed above can be realized in the form of information stored in volatile or non-volatile computer or device readable medium. This is deemed to include at least media such as CD-ROM, magnetic media, flash ROM, etc., storing machine executable instructions, or source code, or any other information that can be used to enable or configure computing devices to perform the various embodiments discussed above. This is also deemed to include at least volatile memory such as RAM storing information such as CPU instructions during execution of a program carrying out an embodiment.

1. One or more computer readable media storing information for allowing a computer to perform a process of determining a value of a type of performance parameter of a target device configuration that comprises known values of various types of configuration attributes that are related to the type of performance parameter, the process comprising:
obtaining reference device configurations respectively having known values for types of configuration attributes corresponding to the types of configuration attributes of the target device and respectively having known values of the type of performance parameter whose value is to be determined for the target device;
weighting the performance parameter values of the reference device configurations based on the reference device configurations' respective distances from the target device configuration in a space defined by the types of configuration attributes, where the types of configuration attributes correspond to respective dimensions of the space; and
using the weighted performance parameter values of the reference device configurations to determine the performance parameter value of the target device.

2. One or more computer readable media according to claim 1, wherein the target device configuration further comprises an other type of performance parameter whose value is to be determined, and wherein the process is performed in two stages, where in a first stage the obtaining, weighting, and using are performed with one subset of the types of configuration attributes to determine the performance parameter value and in a second stage the obtaining, weighting, and using are performed with another subset of the types of configuration attributes to determine the value for the other type of performance parameter.

3. One or more computer readable media according to claim 1, wherein the obtaining further comprises applying filtering criteria to obtain the reference device configurations from a device configuration library.

4. One or more computer readable media according to claim 3, wherein the obtaining further comprises selecting a first set of device configurations from the device configuration library, relaxing the filtering criteria, and selecting a second set of device configurations.

5. One or more computer readable media according to claim 1, further comprising scaling the values of the performance parameters of the obtained reference device configurations.

6. One or more computer readable media according to claim 5, further comprising curve-fitting the scaled performance values of the reference device configurations with respect to their weights.

7. One or more computer readable media storing information comprising:
obtaining target device configuration with some known values of types of configuration parameters;
approximating values of respective performance parameters of the target device configuration for corresponding subspaces, the subspaces comprising different subsets of the types of configuration parameters and having dimensionalities corresponding to the number of types of configuration parameters of which they are comprised, the approximating for a given of the subspaces comprising:
obtaining reference device configurations that correspond to the given subspace;
computing distances from the reference device configurations in the given subspace; and
using the distances and known values of the performance parameter of the given reference device configurations to compute an approximation of the performance parameter for the target device.

8. One or more computer readable media according to claim 7, wherein the target device configuration corresponds to a disk drive device.

9. One or more computer readable media according to claim 7, wherein the performance parameters are of types that are measured by testing corresponding devices.

10. One or more computer readable media according to claim 7, where the distances are calculated using a multi-variant distance function.

11. One or more computer readable media according to claim 10, wherein the multi-variant distance function determines a scaling factor that weights the benchmark contributions of configurations in the subspace to compute the approximation of the performance parameter of the target configuration.

12. One or more computer readable media according to claim 7, wherein the approximating further comprises curve fitting the reference device configurations' performance parameter values to obtain a function that is evaluated with the target device's known configuration attribute values.

13. One or more computer readable media according to claim 7, wherein the process further comprises attempting to select reference device configurations based on matching criteria and relaxing the matching criteria responsive to a determination that an insufficient number of reference device configurations were selected.

14. A computer-implemented method, the method comprising:
beginning with a target device configuration having known parameter values of different types and an unknown performance metric;
selecting from a library of reference device configurations select device configurations that have configuration parameter values that satisfy filtering criteria;
finding distances between the target device configuration and the selected device configurations, respectively, in a space defined by the different types of the known parameters;
computing weights based on the distances, respectively; and
using the weights to calculate a value for the unknown performance metric of the target device configuration.

15. A method according to claim 14, wherein the target device configuration corresponds to a CPU.

16. A method according to claim 14, wherein the filter criteria comprises combinations of matching criteria for matching any two or more of cache sizes, bus speeds, manufacturers, and models of the reference device configurations and the target device configuration.

17. A method according to claim 16, wherein the calculating the value for the unknown parameter comprises using the weights to determine a weighted average of the performance parameter values of some or all of the reference device configurations.

18. A computing system according to claim 14, wherein the library of reference device configurations comprises device configurations having values of performance parameters that have been measured by testing actual devices of the types represented by the device configurations.

19. A computing system according to claim 14, wherein the filter criteria has been relaxed responsive to a prior determination that the pre-relaxed filter criteria did not match a number of reference device configurations in the library.

20. A computing system according to claim 19, wherein the distances are calculated by giving values of one of the types of configuration parameters more or less relative weight than values corresponding values of another of the types of configuration parameters.

21. A computing system according to claim 14, wherein the target device configuration corresponds to a disk drive device, and where the types of known configuration parameters includes rotational speed.
